(19) United States
(12) Patent Application Publication
(10) Pub. No.: US 2015/0098477 A1
(43) Pub. Date: Apr. 9, 2015

(54) REVERSIBLE WAVELENGTH CHANNELS FOR OPTICAL COMMUNICATION NETWORKS

(71) Applicants: VERSITECH LIMITED, HONG KONG (CN); THE HONG KONG POLYTECHNIC UNIVERSITY, HONG KONG (CN)

(72) Inventors: Chun-Yin Li, Hong Kong (CN); Ping-Kong Alexander Wai, Hong Kong (CN); Victor On-Kwok Li, Hong Kong (CN)

(73) Assignees: VERSITECH LIMITED, HONG KONG (CN); THE HONG KONG POLYTECHNIC UNIVERSITY, HONG KONG (CN)

(21) Appl. No.: 14/045,258

(22) Filed: Oct. 3, 2013

(51) Int. Cl. H04B 10/25; H04Q 11/00; H04J 14/02

(52) U.S. Cl. CPC H04B 10/2503; H04J 14/02; H04Q 11/0005; H04Q 2011/0016
USPC 370/535; 398/79; 398/48

(57) ABSTRACT

An optical transmission system comprises at least one first connection point and one second connection point arranged to transmit and receive at least one channel signal transmitted via at least one optical means connecting the first connection point and the second connection, wherein each of the at least one channel signal is reversibly configurable to be transmitted in either a first direction or a second direction between the first connection point and the second connection point. A method of transmitting at least one channel signal between a first connection point and a second connection point via at least one optical media in an optical transmission system, wherein each of the at least one channel signals is reversibly configurable to be transmitted in either a first direction or a second direction between the first and the second connection points.

### FIELD OF THE INVENTION

The present invention relates to an optical communications network, and particularly but not exclusively, to wavelength-routed networks for transmitting bandwidth for internet traffic.

### BACKGROUND OF THE INVENTION

Wavelength-routed (WR) networks are one of the important networking infrastructures to provide the required transmission bandwidth for the rapidly increasing Internet traffic. In WR networks, wavelength division multiplexing (WDM) divides the transmission bandwidth of optical fiber into many, if not hundreds of wavelength channels. Two users desiring communication can set up a lightpath connection by simply reserving a wavelength channel on each fiber link of the path between them. Traditionally, all wavelength channels have been allocated the same amount of bandwidth for simplifying and standardizing the implementation and deployment, e.g., the 100 GHz frequency (0.8 nm wavelength) spacing in ITU grids. As transmission technologies advance, wavelength channels will often be under-utilized, i.e. channels are over-provisioned for normal user traffic. To have a better bandwidth utilization, efforts have been made on packing more low data rate traffic into a wavelength channel, using a smaller channel spacing such as 50 and 25 GHz, and more recently, using the variable bandwidth allocation of wavelength channels. While the importance of properly matching channel bandwidth to users' demand has been widely recognized, the mismatch between the ratio of the capacities (numbers of channels) deployed in the two transmission directions of a fiber link has been overlooked.

### SUMMARY OF THE INVENTION

In accordance with a first aspect of the present invention, there is provided an optical transmission system including at least one first connection point and at least one second connection point arranged to transmit and receive at least one channel signal transmitted via at least one optical media connecting the first connection point and the second connection point, wherein each of the at least one channel signal is reversibly configurable to be transmitted in either a first direction or a second direction between the first connection point and the second connection point.

In accordance with a second aspect of the present invention, there is provided a method of transmitting at least one channel signal between a first connection point and a second connection point via at least one optical media in an optical transmission system, comprising the steps of multiplexing a plurality of input signals into at least one channel signal; transmitting the at least one channel signal via the at least one optical media; and demultiplexing the at least one channel signal into a plurality of output signals; wherein each of the at least one channel signals is reversibly configurable to be transmitted in either a first direction or a second direction between the first connection point and the second connection point.

The present invention allows the flexibility to fully utilize the deployed optical means, such as optical fiber network infrastructures to lessen the need for new fiber infrastructure deployments even if the traffic becomes dynamic, or if the traffic patterns have deviated greatly from the original design plan. In addition, the required technologies for implementing the present invention are available in the field, and there is no foreseeable technology bottleneck.

### BRIEF DESCRIPTION OF THE DRAWINGS

FIG. 1 shows three nodes of a WR network with the reversible wavelength channels in accordance with the present invention;

FIG. 2 shows a reconfigurable bidirectional optical amplifier for use in the WR network of FIG. 1;

FIG. 3 shows a WR node with reversible wavelength channels and wavelength conversion capability;

FIG. 4 shows a 4×4 mesh network as embodied in the present invention;

FIG. 5 shows the NSFNet (1991) network topology as embodied in the present invention;

FIG. 6 shows blocking performance of the embodied reversible wavelength channel approach on the 16-node ring network with symmetric total traffic. There are 32 wavelength channels per fiber. Maximum absolute per node loadings of the curves with pluses and circles: 32 erlangs, curves with diamonds: 64 erlangs, curves with crosses and squares: 128 erlangs, and curves with triangles: 256 erlangs;

FIG. 7 shows blocking performance of the embodied reversible wavelength channel approach on the 4×4 mesh network with symmetric total traffic, with the same traffic parameters as those of FIG. 6;

FIG. 8 shows blocking performance of the proposed reversible wavelength channel approach on the NSFNet topology network with symmetric total traffic, with the same traffic parameters as those of FIG. 6;

FIG. 9 shows blocking performance of the proposed reversible wavelength channel approach on the NSFNet topology network with different asymmetry factors. There are 32 wavelength channels per fiber but only one fiber per link. The maximum absolute per node loadings of all curves are 32 erlangs;

FIG. 10 shows blocking performance of the proposed reversible wavelength channel approach on the NSFNet topology network with different asymmetry factors. There are 32 wavelength channels per fiber and four fibers per link. The maximum absolute per node loadings of all curves are 128 erlangs;

FIG. 11 shows blocking performance of the reversible waveband approach on the NSFNet topology network with symmetric total traffic. There are 32 wavelength channels per fiber but only one fiber per link. The maximum absolute per node loadings of all curves are 32 erlangs;

FIG. 12 shows blocking performance of the reversible waveband approach on the NSFNet topology network with symmetric total traffic. There are 32 wavelength channels per fiber and four fibers per link. The maximum absolute per node loadings of all curves are 128 erlangs;

FIG. 13 shows blocking performance of reversible waveband approach on NSFNet topology network with different asymmetry factors. There are 32 wavelength channels per fiber but only one fiber per link. The maximum absolute per node loadings of all curves are 32 erlangs; and

FIG. 14 shows blocking performance of reversible waveband approach on NSFNet topology network with different asymmetry factors. There are 32 wavelength channels per fiber and four fibers per link. The maximum absolute per node loadings of all curves are 128 erlangs.

### DETAILED DESCRIPTION OF THE PREFERRED EMBODIMENTS

The present invention relates to an optical transmission system comprising at least one first connection point and at least one second connection point arranged to transmit and receive at least one channel signal transmitted via at least one optical media connecting the first connection point and the second connection point, wherein each of the at least one channel signals is reversibly configurable to be transmitted in either a first direction or a second direction between the first connection point and the second connection point.

The present invention also relates to a method of transmitting of transmitting at least one channel signal between a first connection point and a second connection point via at least one optical media in an optical transmission system, comprising the steps of multiplexing a plurality of input signals into at least one channel signals, transmitting the at least one channel signal via the at least one optical media, and demultiplexing the at least one channel signal into a plurality of output signals, wherein each of the at least one channel signal is reversibly configurable to be transmitted in either a first direction or a second direction between the first connection point and the second connection point.

Specifically, the at least one channel signals includes at least one wavelength channel. The at least one optical media includes at least one optical fiber, and that the first direction and the second direction are opposite to each other.

Without wishing to be bound by theory, the inventors through trials, research and study are of the opinion that the present application has significant benefits over the current technology. As a starting point in the consideration of the usage of a reversible channel signal, and particularly, a wavelength channel for optical communication networks, the inventors have observed through study that the present invention has specific benefits. For example, in most deployed WR networking infrastructures, the links connecting two nodes are often assigned the same number of channels in both transmission directions. The assumption is that the volumes of traffic in both transmission directions of a link are often nearly equal. However, the inventors have recognized that in the real world, however, traffic between users are often not necessarily symmetric, not to mention the frequent changes of traffic patterns in today's networks. As the Internet becomes an increasingly important resource of information and entertainment, we are facing local and global networks with increasingly dynamic traffic patterns.

Although light beams raveling along a fiber optic cable are significantly different from material objects, the inventors have very surprisingly taken inspiration from objects in the physical world. The recognition that light is sometimes analogous to a physical object provides a comparison which can help to explain the invention. If we analogize optical fibers to roads, then the wavelength channels may be considered as lanes. In highway systems, reversible lanes have already been regarded as one of the most cost-effective methods to provide additional capacity for periodic unbalanced directional traffic demand while minimizing the total number of lanes on a roadway. Undoubtedly, the negative impact of asymmetric traffic distribution will be mitigated in WR networks if the transmission directions of all wavelength channels can be freely reversed according to the needs of the traffic condition, i.e., with reversible wavelength channels.

Proposals to accommodate wavelength channels with different transmission directions into a single fiber similar to that of roads have been made, e.g. passive optical networks and single fiber bidirectional rings (C. H. Kim C. H. Lee, and Y. C. Chung, “Bidirectional WDM self-healing ring network based on simple bidirectional add/drop amplifier modules,” IEEE Photonics Technology Letters, Vol. 10, No. 9, pp. 1340-1342, 1998; S. B. Park, C. H. Lee, S. G. Kang and S. B. Lee, “Bidirectional WDM self-healing ring network for hub/remote nodes,” IEEE Photonics Technology Letters, Vol. 15, No. 11, pp. 1657-1659, 2003; X. Sun, et al “A single-fiber bi-directional WDM self-healing ring network with bi-directional OADM for metro-access applications” Journal on Selected Area in Communications, Vol. 25, No. 4, pp. 18-24, 2007). However, these proposals are mainly for reducing the deployment and operation costs of optical fiber networks.

The inventors have surprisingly discovered that the performance benefits and efficiency increase enabled by employing reversible wavelength channels has been neglected, even though most of the required technologies such as bidirectional couplers (M. S. Lee, I. K. Hwang, and B. Y. Kim, “Bidirectional wavelength-selective optical isolator,” Electronics Letters, Vol. 37, No. 14, pp. 910-912. 2001; X. K. Hu, et al, “A wavelength selective bidirectional isolator for access optical networks,” Optical Fiber Technology, Vol. 17, pp. 191-195, 2011), bidirectional add-drop multiplexers (K. P. Ho, S. K. Liaw, and Chinlon Lin, “Performance of an eight-wavelength bidirectional WDM add/drop multiplexer with 80-Gbit/s capacity,” Proceedings of OFC 1997, pp. 90-91, 1997; Y. Shen, X. Wu, C. Lu, T. H. Cheng, and M. K. Rao, “A Novel Single-Fiber Bidirectional Optical Add/Drop Multiplexer for Distribution Networks,” Proceedings of OFC 2001, paper WY5, 2001; A. V. Tran, C. J. Chae, and R. S. Tucker, “A bidirectional optical add-drop multiplexer with gain using multiport circulators, fiber Bragg gratings, and a single unidirectional optical amplifier,” IEEE Photonics Technology Letters, Vol. 17, No. 7, pp. 975-977, 2003; S. K. Liaw, et al, “Bidirectional reconfigurable optical add-drop multiplexer with power compensation built-in optical amplifiers,” Journal of Optical Networking, Vol. 7, No. 7, pp. 662-672, 2008), bidirectional optical amplification (J. M. P. Delavaux, et al, “WDM repeaterless bi-directional transmission of 73 channels at 10 Gbit/s over 126 km of True Wave fiber,” Proceedings of ECOC 1997, pp. 21-23, 1997; C. H. Chang and Y. K. Chen, “Demonstration of repeaterless bidirectional transmission of multiple AM-VSB CATV signals over conventional single-mode fiber,” IEEE Photonics Technology Letters, Vol. 12, No. 6, pp. 734-736, 2000; H. H. Lu, H. L. Ma, and C. T. Lee, “A Bidirectional hybrid DWDM system for CATV and OC-48 trunking,” IEEE Photonics Technology Letters, Vol. 13, No. 8, pp. 902-904, 2001; M. Karasek, J. Vojtech, and J. Radil, “Bidirectional repeaterless transmission of 8×10 GE over 210 km of standard single mode fibre,” IET Optoelectron., Vol 1, No. 2, pp. 96-100, 2007; M. Oskar van Deventer and O. J. Koning “Bidirectional transmission using an erbium-doped fiber amplifier without optical isolators,” IEEE Photonics Technology Letters, Vol. 7, No. 11, pp. 1372-1274, 1995; S. K. Liaw, K. P. Ho, Chinlon Lin, and S. Chi, “Multichannel bidirectional transmission using a WDM MUX/DMUX pair and unidirectional in-line amplifiers,” IEEE Photonics Technology Letters, Vol. 9, No. 12, pp. 1664-1666, 1997; C. H. Kim, C. H. Lee and Y. C. Chung, “A novel bidirectional add/drop amplifier (BADA)” IEEE Photonics Technology Letters, Vol. 10, No. 8, pp. 1118-1120, 1998; L. D. Garrett, et al, “Bidirectional ULH transmission of 160-Gb/s full-duplex capacity over 5000 km in a fully bidirectional recirculating loop,” IEEE Photonics Technology Letters, Vol. 16, No. 7, pp. 1757-1759, 2004; M. H. Eiselt, et al., “Field trial of a 1250-km private optical network based on a single-fiber, shared-amplifier WDM system,” Proceedings of NFOEC 2006, paper NThF3, 2006), and bidirectional optical switches (J. Kim and B. Lee, “Independently switchable bidirectional optical cross connects,” IEEE Photonics Technology Letters, Vol. 12, No. 6, pp. 693-695, 2000; S. Kim “Bidirectional optical cross connects for multiwavelength ring networks using single arrayed waveguide grating router,” Journal of Lightwave Technology, Vol. 20, No. 2, pp. 188-194, 2002; H. Yuan, W. D. Zhong, and W. Hu, “FBG-based bidirectional optical cross connects for bidirectional WDM ring networks,” Journal of Lightwave Technology, Vol. 22, No. 12, pp. 2710-2721, 2004; S. K. Liaw, P. S. Tsai, K. Y. Hsu, and A. Tverjanovich, “Power-compensated 3×3 reconfigurable bidirectional multiwavelength cross-connect device based on strain tunable fiber Bragg gratings,” Proceedings of NoC 2011, paper CPI-6. 2011; P. Ghelfi, et al, “Optical cross connects architecture with per-node add & drop functionality,” Proceedings of NFOEC 2007, paper NTuC3, 2007) are already available. However, to our knowledge no study on a reversible wavelength channel for optical communication networks has been reported. Thus, this appears to be a technological blind-spot which the inventors have now peered more deeply into. By conducting significant research and effort into this hidden application, the inventors have recognized the potential efficiency increase and dynamic flexibility increase enabled by these existing technologies.

The usage of reversible wavelength channels for use in wavelength-routed (WR) networks and specifically, wavelength division multiplexing (WDM) utilizes components in existing infrastructure more efficiently, thereby allowing networks a previously-impossible flexibility to fully utilize the deployed optical fiber network infrastructure. This may reduce the need for new fiber infrastructure deployments, installations, and extensions even if the traffic becomes more dynamic, or if the traffic patterns deviate greatly from the original design plans. The reversible wavelength channels also allow easier upgrading of the WDM network by adding additional devices to existing networks, rather than by installing completely new fiber infrastructures. Also, as the required technology for reversible wavelength channels is already available, there is no foreseeable technology bottleneck for implementation.

TABLE 1
Required transmission bandwidth between
nodes in wavelength channels

| | destination | | |
|---|---|---|---|
| source | Node 1 | Node 2 | Node 3 |
| Node 1 | 0 | 1 | 0 |
| Node 2 | 2 | 0 | 1 |
| Node 3 | 1 | 2 | 0 |

### A. Principle and System Requirements

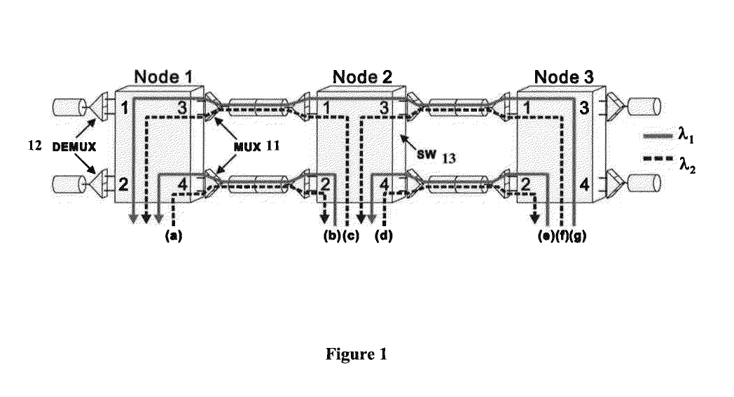

FIG. 1 shows three nodes (labeled with Node 1, Node 2 and Node 3) of a WR network with reversible wavelength channels. A node is simply represented by a combination of wavelength multiplexers (MUX 11), demultiplexers (DEMUX 12) and optical switch (SW 13). Specifically, these wavelength multiplexers (MUX 11), demultiplexers (DEMUX 12) and optical switch (SW 13) are bidirectional. More specifically, the multiplexers (MUX 11) is for multiplexing a plurality of input signals into the one channel signal; the demultiplexers (DEMUX 12) is for demultiplexing the at least one channel signal into a plurality of output signals, and the optical switch (SW 13) is for switching transmission of the at least one channel signal between two optical fibers. At least one of the nodes may include an electronic device.

In FIG. 1, each node has four fibers connected to its adjacent nodes and there are two wavelength channels (λ₁ and λ₂) per fiber, i.e., Ports 1 and 2 of a node are connected to Ports 3 and 4 of its adjacent node in the figure. Assuming that the required data transmission bandwidth between nodes in units of wavelength channels (also shown in Table I) are (1) Node 1 receives two units from Node 2 and one unit from Node 3, (2) Node 2 receives one unit from Node 1 and two unit from Node 3, and (3) Node 3 receives one unit from Node 2. This requires us to allocate three wavelength channels connecting from Node 3 to Node 2 and another three from Node 2 to Node 1. Also, we need one wavelength channel connecting from Node 1 to Node 2 and another one from Node 2 to Node 3. If this is a traditional WR network, there will be a problem to set up lightpaths to meet such bandwidth requirement, since traditional WR networks only have non-reversible wavelength channels, each with a fixed transmission direction. Most likely, the two fibers connecting two nodes are in opposite transmission directions. It would thus be impossible to set up the required efficient lightpaths within these three nodes in a traditional WR network. Therefore the system would need to block some of the transmission requests.

On the other hand, according to the present invention, we may set up lightpaths (a) to (g) as shown in FIG. 1 if the wavelength channel directions are reversible. The wavelength channels in the upper two fibers of FIG. 1 are configured with a transmission direction from right to left. Those in the lower two fibers are configured with Channel λ₁ to left and Channel λ₂ to right, i.e., the lower two fibers in FIG. 1 are bidirectional transmission fibers.

Reversible wavelength channels allow the flexibility to fully utilize the deployed optical fiber network infrastructures to lessen the need for new fiber infrastructure deployments even if the traffic becomes dynamic, or if the traffic patterns have deviated greatly from the original design plans. Note that fiber infrastructures are one of the major investments in optical fiber communication networks. As shown in FIG. 1, however, reversible wavelength channels will require WR network devices to be bidirectional and reconfigurable.

First of all, to maximize flexibility, in an embodiment herein each wavelength channel on a fiber is reconfigurable to support data transmission in either direction. Note that a reversible wavelength channel, like a reversible lane in a highway system, can have transmission in only one direction at any moment but with flexibility of the direction being configurable at the setup of a lightpath. We do not consider the case of transmissions in two channels with the same wavelength but different directions because one skilled in the art understands that it is possible with short distance fiber links only (M. Oskar van Deventer, Fundamentals of bidirectional transmission over a single optical fibre, Boston: Kluwer Academic, 1996). As wavelength multiplexers and demultiplexers are in general passive devices and bidirectional, a fiber without an isolator to limit the optical signal reflection can be considered as a bidirectional link. Recently, bidirectional isolators have also been proposed to improve the transmission performance of bidirectional fiber links (M. S. Lee, I. K. Hwang, and B. Y. Kim, “Bidirectional wave-length-selective optical isolator,” Electronics Letters, Vol. 37, No. 14, pp. 910-912. 2001; X. K. Hu, et al, “A wavelength selective bidirectional isolator for access optical networks,” Optical Fiber Technology, Vol. 17, pp. 191-195, 2011), i.e., a single fiber with channels in different directions. In an embodiment herein, reversible wavelength channels may contain bidirectional isolators to be reconfigurable and the required technologies have already been demonstrated in other devices such as bidirectional add-drop multiplexers (K. P. Ho, S. K. Liaw, and Chinlon Lin, “Performance of an eight-wavelength bidirectional WDM add/drop multiplexer with 80-Gbit/s capacity,” Proceedings of OFC 1997, pp. 90-91, 1997; Y. Shen, X. Wu, C. Lu, T. H. Cheng, and M. K. Rao, “A Novel Single-Fiber Bidirectional Optical Add/Drop Multiplexer for Distribution Networks,” Proceedings of OFC 2001, paper WY5, 2001; A. V. Tran, C. J. Chae, and R. S. Tucker, “A bidirectional optical add-drop multiplexer with gain using multiport circulators, fiber Bragg gratings, and a single unidirectional optical amplifier,” IEEE Photonics Technology Letters, Vol. 17, No. 7, pp. 975-977, 2003; S. K. Liaw, et al, “Bidirectional reconfigurable optical add-drop multiplexer with power compensation built-in optical amplifiers,” Journal of Optical Networking, Vol. 7, No. 7, pp. 662-672, 2008). The bidirectional isolators is for limiting reflection of the at least one channel signal.

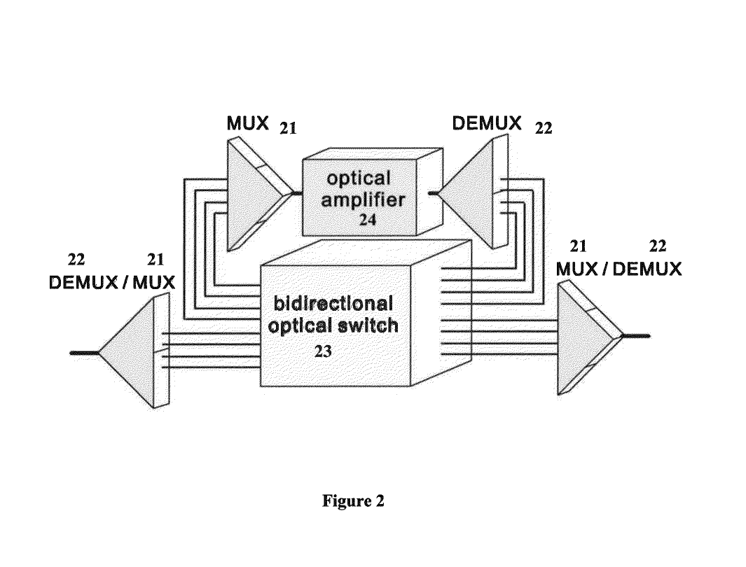

In an embodiment herein, the reversible wavelength channels may be optically amplified by a bidirectional amplifier if the distance between nodes is long. Commercially available optical amplifiers for long distance transmissions are not bidirectional. There have been many proposals for optical amplification of bidirectional fiber links including repeaterless approaches pre and post amplifying the optical signals at transmitters and receivers, respectively, instead of adding a bidirectional optical amplifier at the middle of the transmission path (J. M. P. Delavaux, et al, “WDM repeaterless bi-directional transmission of 73 channels at 10 Gbit/s over 126 km of True Wave fiber,” Proceedings of ECOC 1997, pp. 21-23, 1997; C. H. Chang and Y. K. Chen, “Demonstration of repeaterless bidirectional transmission of multiple AM-VSB CATV signals over conventional single-mode fiber,” IEEE Photonics Technology Letters, Vol. 12, No. 6, pp. 734-736, 2000; H. H. Lu, H. L. Ma, and C. T. Lee, “A Bidirectional hybrid DWDM system for CATV and OC-48 trunking,” IEEE Photonics Technology Letters, Vol. 13, No. 8, pp. 902-904, 2001; M. Karasek, J. Vojtech, and J. Radil, “Bidirectional repeaterless trans-mission of 8×10 GE over 210 km of standard single mode fibre,”IET Optoelectron., Vol. 1, No. 2, pp. 96-100, 2007), and repeated approaches adding bidirectional optical amplifiers in the path (M. Oskar van Deventer and O. J. Koning “Bidirectional transmission using an erbium-doped fiber amplifier without optical isolators,” IEEE Photonics Technology Letters, Vol. 7, No. 11, pp. 1372-1274, 1995; S. K. Liaw, K. P. Ho, Chinlon Lin, and S. Chi, “Multichannel bidirectional transmission using a WDM MUX/DMUX pair and unidirectional in-line amplifiers,” IEEE Photonics Technology Letters, Vol. 9, No. 12, pp. 1664-1666, 1997; C. H. Kim, C. H. Lee and Y. C. Chung, “A novel bidirectional add/drop amplifier (BADA)” IEEE Photonics Technology Letters, Vol. 10, No. 8, pp. 1118-1120, 1998; L. D. Garrett, et al, “Bidirectional ULH transmission of 160-Gb/s full-duplex capacity over 5000 km in a fully bidirectional recirculating loop,” IEEE Photonics Technology Letters, Vol. 16, No. 7, pp. 1757-1759, 2004; M. H. Eiselt, et al., “Field trial of a 1250-km private optical network based on a single-fiber, shared-amplifier WDM system,” Proceedings of NFOEC 2006, paper NThF3, 2006). The inventors believe that using bidirectional optical amplifiers will allow the networks to have a larger coverage. Among the proposed bidirectional optical amplifiers, the co-propagating amplifier architecture (L. D. Garrett, et al. and M. H. Eiselt, et al.) is suggested as the building block for the required reconfigurable bidirectional optical amplifiers as shown in FIG. 2. This is because commercially available high performance erbium doped fiber amplifiers (EDFAs) optimized for low noise figure and high output power are fundamentally unidirectional devices. Also, the good performance of co-propagating architecture bidirectional amplifiers have been demonstrated in both laboratory and field trials. By adding the bidirectional optical switch 23, the optical signals from left and right fibers in FIG. 2 can pass through the optical amplifier 24 and be routed to the proper channels of fibers at the opposite sides.

A lightpath can span two or more fiber links, e.g., lightpath (g) in FIG. 1. Hence, the optical switches in the intermediate nodes should also support bidirectional transmissions between the two or more fiber links. In principle, the optical switches built with micro-mirrors using micro electro mechanical systems (MEMS) technology are in nature bidirectional (J. Kim, et at., “1100×1100 port MEMS-based optical crossconnect with 4-dB maximum loss” IEEE Photonics Technology Letters, Vol. 5, No. 11, pp. 537-1539, 2003; S. J. B. Yoo, “Optical packet and burst switching technologies for the future photonic Internet,” Journal of Lightwave Technology, Vol. 24, No. 12, pp. 4468-4492, 2006; S. Sygletos, I. Tomkos, and J. Leuthold, “Technological challenges on the road toward transparent networking,” Journal of Optical Networking, Vol. 7, No. 4, pp. 321-350, 2008). Although MEMS optical switches have the advantage of low crosstalk, low insertion loss, and up to a thousand input/output ports, their cost and reliability issues have encouraged other kinds of bidirectional optical switches to be proposed with technologies such as tunable fiber grating and/or arrayed waveguide grating (AWG) (J. Kim and B. Lee, “Independently switchable bidirectional optical cross connects,” IEEE Photonics Technology Letters, Vol. 12, No. 6, pp. 693-695, 2000; S. Kim “Bidirectional optical cross connects for multiwavelength ring networks using single arrayed waveguide grating router,” Journal of Lightwave Technology, Vol. 20, No. 2, pp. 188-194, 2002; H. Yuan, W. D. Zhong, and W. Hu, “FBG-based bidirectional optical cross connects for bidirectional WDM ring networks,” Journal of Lightwave Technology, Vol. 22, No. 12, pp. 2710-2721, 2004; S. K. Liaw, P. S. Tsai, K. Y. Hsu, and A. Tverjanovich, “Power-compensated 3×3 reconfigurable bidirectional multiwavelength cross-connect device based on strain tunable fiber Bragg gratings,” Proceedings of NoC 2011, paper CPI-6. 2011; P. Ghelfi, et al, “Optical cross connects architecture with per-node add & drop functionality,” Proceedings of NFOEC 2007, paper NTuC3, 2007). However, the scalability of such bidirectional optical switches at the moment is not as good as that of MEMS optical switches.

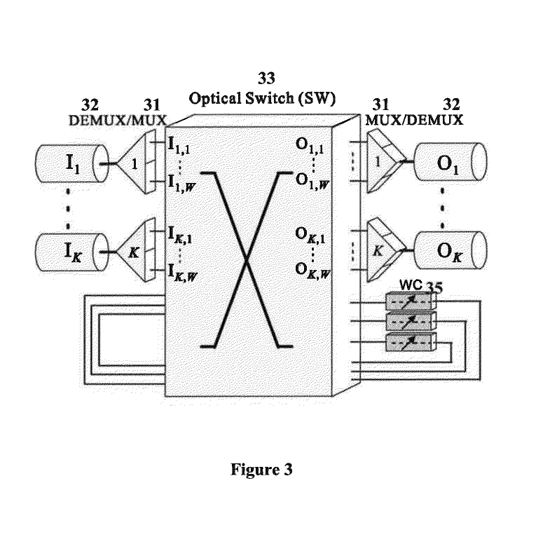

Lightpaths passing through the same fiber link must be assigned channels of different wavelengths regardless of the lightpath direction. Wavelength contention may therefore also occur when we set up new lightpaths in networks with reversible wavelength channels. Actually, it is as necessary to solve the routing and wavelength assignment (RWA) problem as in normal WR networks except that lightpaths having opposite directions can pass through the same fiber link, e.g., lightpaths (a) and (b) in FIG. 1. Wavelength converters (WCs) for converting the wavelength channels so that the channels are adapted to be transmitted by the same optical fiber link, can be used to reduce the lightpath setup blocking probability caused by wavelength contentions. In normal WR networks, WCs can be added at either the inputs or outputs of the optical switch in a WR node. However, such approaches may not be applicable in this case because the WC must be transmission direction reconfigurable. A more feasible approach is as shown in FIG. 3, i.e., optical signals from both sides of the RW node can be wavelength converted by the shared-by-node WCs 35 (K. C. Lee, and V. O. K. Li, “A wavelength-convertible optical network,” Journal of Lightwave Technology, Vol. 11, No. 5, pp. 962-970, 1993) before being switched to their preferred fiber links.

A WR node should be able to transmit/receive the local user data to/from the proper wavelength channels of the proper fibers. In FIG. 1, Node 3 can send local user data to channels (λ₁ and λ₂) on fiber connected to Port 1 and Channel λ₁ on fiber connected to port 2 so that Node 1 can receive the data from those channels, i.e., the lightpaths (e), (f) and (g). As each wavelength channel can serve as input and output, the bidirectional optical switches inside the nodes should be able to connect a user transmitter/receiver to any channel of any fiber connected to the node. In an embodiment herein the optical switches can provide per-node add-drop functionality (P. Ghelfi, et al, “Optical cross connects architecture with per-node add & drop functionality,” Proceedings of NFOEC 2007, paper NTuC3, 2007). Depending on implementation considerations, bidirectional add-drop multiplexers may also be first used on each port (K. P. Ho, S. K. Liaw, and Chinlon Lin, “Performance of an eight-wavelength bidirectional WDM add/drop multiplexer with 80-Gbit/s capacity,” Proceedings of OFC 1997, pp. 90-91, 1997; Y. Shen, X. Wu, C. Lu, T. H. Cheng, and M. K. Rao, “A Novel Single-Fiber Bidirectional Optical Add/Drop Multiplexer for Distribution Networks,” Proceedings of OFC 2001, paper WY5, 2001; A. V. Tran, C. J. Chae, and R. S. Tucker, “A bidirectional optical add-drop multiplexer with gain using multiport circulators, fiber Bragg gratings, and a single unidirectional optical amplifier,” IEEE Photonics Technology Letters, Vol. 17, No. 7, pp. 975-977, 2003; S. K. Liaw, et al, “Bidirectional reconfigurable optical add-drop multiplexer with power compensation built-in optical amplifiers,” Journal of Optical Networking, Vol. 7, No. 7, pp. 662-672, 2008), e.g., Ports 1, 2, 3 and 4 in FIG. 1. Nevertheless, extra hardware is then needed to provide the per-node add-drop functionality.

The numbers of transmitters and receivers of a k-degree normal WR node with f fibers per link and w channels per fiber are kfw because they should be equal to the numbers of available output and input wavelength channels, e.g., there will be four transmitters and four receivers in each node of FIG. 1 for a normal WR network. As in the proposed system a node can configure all its available wavelength channels as either inputs or outputs, we can in principle install up to 2kfw transmitters and receivers at a node to have the best system performance. However, the maximum utilization of transmitters and receivers will only be 50% in this case. In general, the numbers of transmitters and receivers of reversible wavelength channels can be equal to that of normal WR networks if the fluctuation of traffic distribution is not drastic. In the following sections, we will discuss the demonstrated significant performance improvement that can be obtained with reversible wavelength channels even if only kfw transmitters and receivers per node are used.

The above discussions show that most of the required technologies for reversible wavelength channels are already available, and there is no foreseeable technology bottleneck. Reversible wavelength channels allow us to upgrade WR network by using additional devices rather than by installing new fiber infrastructures.

### B. Application Scenarios

At the moment, reversible wavelength channels are likely to be more suitable for access/metro networks because of the dynamic traffic characteristic and the less stringent optical signal power tolerance. Reversible wavelength channels could provide significant improvement to the blocking performance even if the network traffic is statistically symmetric, i.e., on average the intensity of traffic from Node A to Node B equals that from Node B to Node A. Obviously, reversible wavelength channels will add little gain if the traffic symmetry is deterministic, e.g., another connection must be set up from Node B to Node A simultaneously when a connection is set up from Node A to Node B. Also, networks with highly static traffic will not benefit from the flexibility of reversible wavelength channels. Therefore, wavelength reversible channels may not be attractive to current optical backbones because their traffic is highly aggregated on high capacity trunks. In contrast, a recent study shows that the traffic characteristics of access/metro networks are rather dynamic and asymmetric (G. Maier, A. Feldmann, V. Paxson, and M. Allman “On dominant characteristics of residential broadband internet traffic,” Proceedings of the 9th ACM SIGCOMM conference on Internet measurement conference (IMC 2009), 2009). Therefore the present invention may be useful in such networks.

Unlike systems with a fixed channel direction, the optical signals in an embodiment of our proposed system possess extra demultiplexing/multiplexing and switching processes when they are re-amplified (see the optical amplifier shown in FIG. 2) because of the direction configurability of each wavelength channel. The signal power loss caused by the extra processes may be up to 5 to 10 dB depending on the implementation details. It is preferable that the signal attenuation between nodes is reduced such that the quality of the optical signals is still above the minimum requirements after the additional processing. Otherwise, optical amplifiers with larger gain and higher output power will be needed to compensate for the extra signal power loss, i.e., longer erbium doped fiber, stronger pump laser, and multistage approach will have to be used for the EDFAs (R. I. Laming and D. N. Payne, “Noise characteristic of Erbium-doped fiber amplifier pumped at 980 nm,” IEEE Photonics Technology Letters, Vol. 2, No. 6, pp. 418-421, 1990; R. G. Smart, J. L. Zyskind, J. W. Sulhoff, and D. J. DiGiovanni, “An investigation of the noise figure and conversion efficiency of 0.98 μm pumped Erbium-doped fiber amplifiers under saturated conditions,” IEEE Photonics Technology Letters, Vol. 4, No. 11, pp. 1261-1264, 1992; H. Bulow and Th. Pfeiffer, “Calculation of the noise figure of Erbium-doped fiber amplifiers using small signal attenuations and saturation powers,” IEEE Photonics Technology Letters, Vol. 4, No. 12, pp. 1351-1354, 1992). Apart from the extra cost incurred, physical layer issues such as optical signal to noise ratio (OSNR) will be a concern when using higher power optical amplifiers. Hence, networks with tight link budget and stringent OSNR requirement such as the optical backbones may require significant effort to integrate the reversible wavelength channels into the system. On the other hand, all these issues are easier to handle in the access/metro networks.

The inventors herein recognize that further complications will arise if Raman amplifiers (M. N. Islam, “Raman amplifiers for telecommunications,” IEEE Journal of Selected Topics in Quantum Electronics, Vol. 8, No. 3, pp. 548-559, 2002), instead of EDFAs, are used to amplify the signals. Despite its many advantages, Raman amplification is polarization-dependent, i.e. Raman gain depends on the mutual orientation of the states of polarization of the pump and signal waves. As most optical fibers are slightly birefringent, typical Raman amplifiers will use the backward pumping scheme such that the polarizations of the Raman pump and the signal will be rapidly varying relative to each other. The Raman gain will then be effectively averaged. Thus the inventors herein recognize that polarization-dependent gain such as that obtained with Raman amplifiers or optical parametric amplifiers poses a significant challenge to reversible wavelength channels. Bi-directional pumping, polarization scrambling, and polarization diversity can be used to alleviate the polarization dependence of the Raman gain at the expense of increasing hardware cost and system complexity. Therefore, in an embodiment herein, the optical transmission system herein is substantially free of Raman amplification and/or Raman amplifiers.

### C. Performance Evaluation

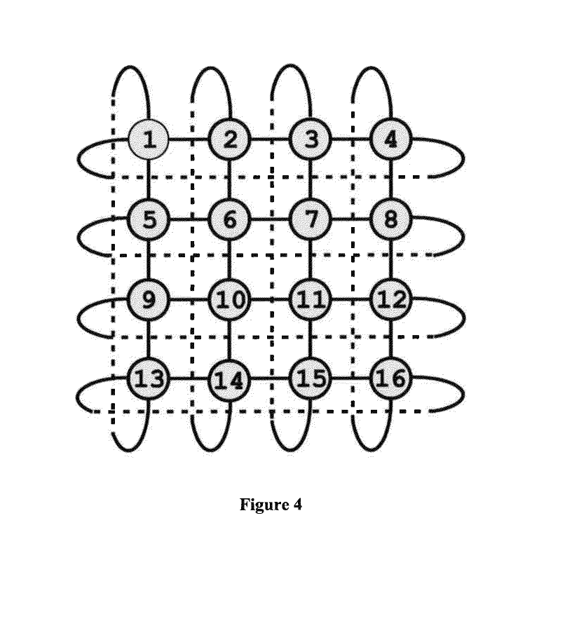

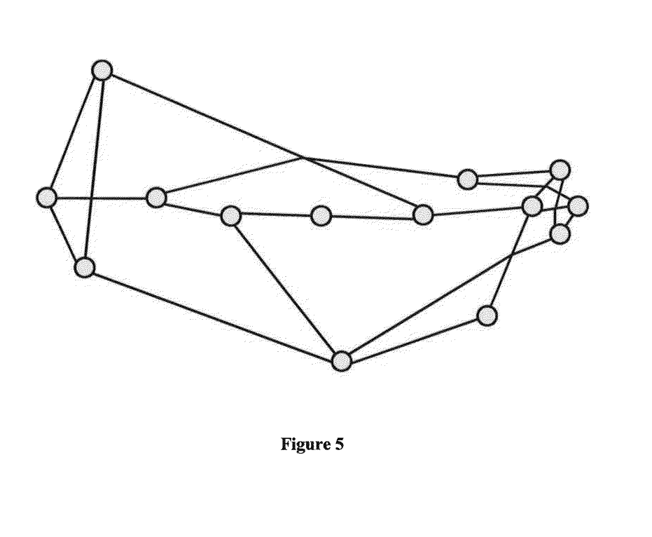

We first demonstrate the blocking performance of the proposed reversible wavelength channel approach on the 16-node ring network, the 4×4 mesh network (FIG. 4), and the NSFNet topology network (FIG. 5) with the assumption that the total traffic in each direction of a pair of nodes are statistically symmetric, i.e., the traffic from Node A to Node B will be on the average equal to that of Node B to Node A. We therefore will have a general concept of the performance of the reversible wavelength channel approach on regular topology (ring and mesh) and irregular topology (NSFNET) networks. In the simulations, two adjacent nodes of a network are connected by two links which have opposite transmission directions if the normal WR network approach is used. For the reversible wavelength channel approach being used, however, the transmission directions of all wavelength channels in the two links are reversible. There may be one, two, four, and eight fibers per link, depending on the simulation requirement. We assume that there are 32 wavelength channels per fiber. A user data transmission request arrives at the system as a Poisson process and chooses a random pair of source and destination nodes. Shortest path routing is used to set up the required lightpath. After a lightpath has been set up between the source and destination, the holding time of the lightpath will be an exponential random number with a mean of one time unit. If there is no wavelength channel available on any link of the path, the data transmission request will be blocked. The numbers of transmitters and receivers in a k-degree normal WR node is kfw where f is number of fibers per link and w is the number of channels per fiber. We assume that there are also kfw transmitters and receivers in the k-degree node of the networks with reversible wavelength channels. We use the batched mean method (batch size of 10⁴ time units) with discarding the first batch to compute the results. All simulations are run sufficiently long such that 95% confidence intervals are less than 1% of the results.

In normal WR networks, two lightpaths with the same end nodes but opposite directions will never have bandwidth and wavelength contentions with each other. It is because path (n₁,nₖ)={n₁, n₂, . . . nₖ} implies path (nₖ,n₁)={nₖ, nₖ₋₁, . . . n₁} from shortest routing and fiber links with opposite directions are used to connect node pairs (nₓ, n_{y}) and (n_{y}, nₓ). Hence, a normal WR network can be considered as two independent networks each of which has its own sets of lightpaths and fiber links if we partition the lightpaths and fiber links according to their transmission directions. Note that this observation may not be valid if the lightpath routing is not shortest path routing. With reversible wavelength channels, it is conceptually equal to combining the link capacities and traffic loadings of the two independent networks. Evidently, the lightpath setup blocking probability will be much smaller regardless of the traffic distributions since it is well-known that doubling a link capacity will improve the blocking performance even if the loading is also doubled (F. P. Kelly, “Block probabilities in large circuit-switched networks,” Advances in Applied Probability, Vol. 18, pp. 473-505, 1986). Hence, the proposed reversible wavelength channel approach should also provide performance improvement in the symmetric traffic situations. To demonstrate the validity of the concept, we also plot the results of WR networks with double the link capacity and traffic loading in symmetric traffic situations. Their blocking probabilities should be very close to that of reversible wavelength channels.

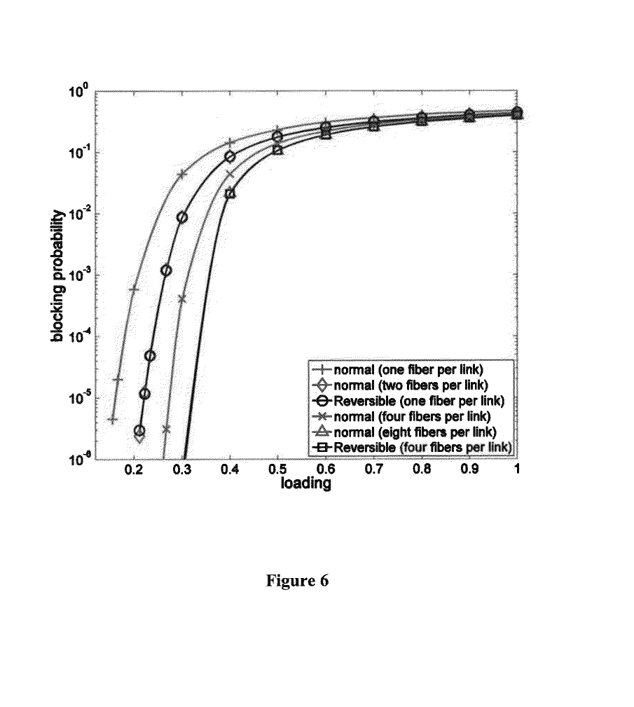

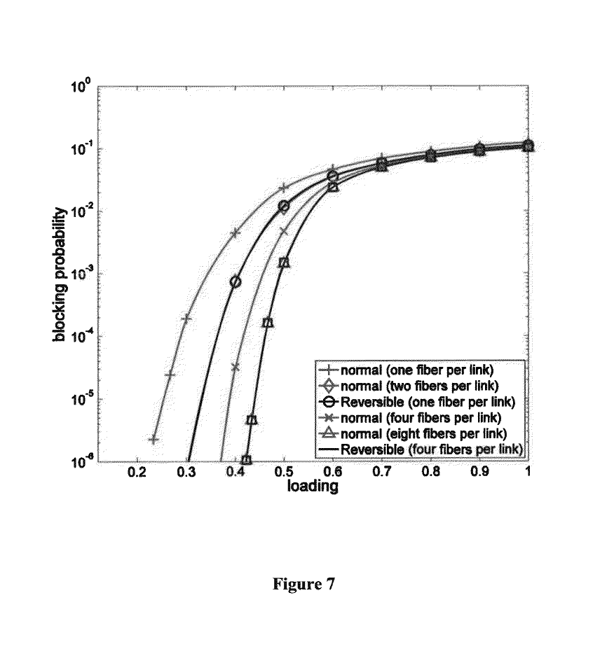

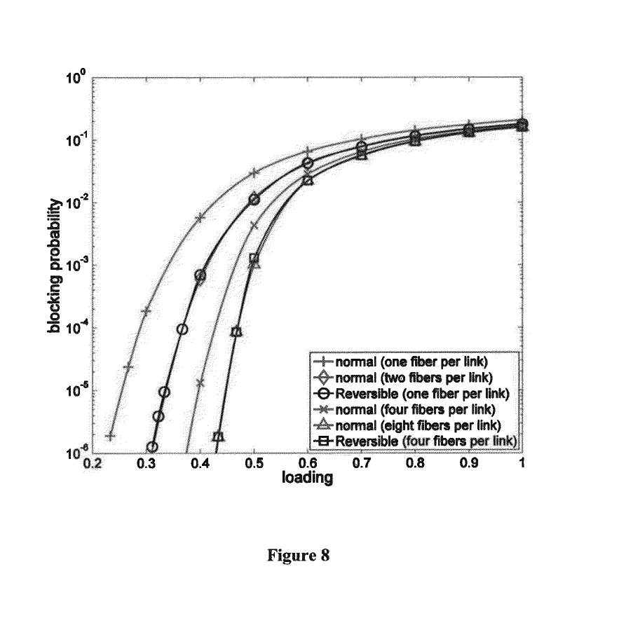

FIGS. 6 to 8 show the simulation results. The loading in the horizontal axis of the figures is a normalized value of (number of transmission data requests in a time unit)/(number of nodes×number of channels per fiber×number of fibers per link×minimum number of node degree in the network). From this arrangement, we can directly compare the blocking performance of systems with different numbers of fibers per link in the same figure. To allow one to have a rough idea when comparing capacity against loadings, the maximum absolute per node loadings of all curves are also marked in the figures. In the figures, the curves with pluses, diamonds, crosses, and triangles are the blocking probabilities for normal WR networks with one, two, four and eight fibers per link, respectively, while the curves with circles and squares are for those using reversible wavelength channels on networks with one and four fiber per link. From the figures, we observe that significant blocking performance improvement has been obtained no matter of the network topology being ring, mesh and NSFNet. From FIG. 6 to FIG. 8, we observe that the blocking performance of WR networks with reversible wavelength channel is close to that of WR networks with double the link capacity and traffic loading, i.e., the curves with circles and squares are nearly overlapping the curves with diamonds and triangles. Hence, one can confirm that the reversible wavelength channel approach can provide a significant, unexpected performance improvement for different network topologies and different number of fibers per link even if the traffic between any pair of nodes is symmetric.

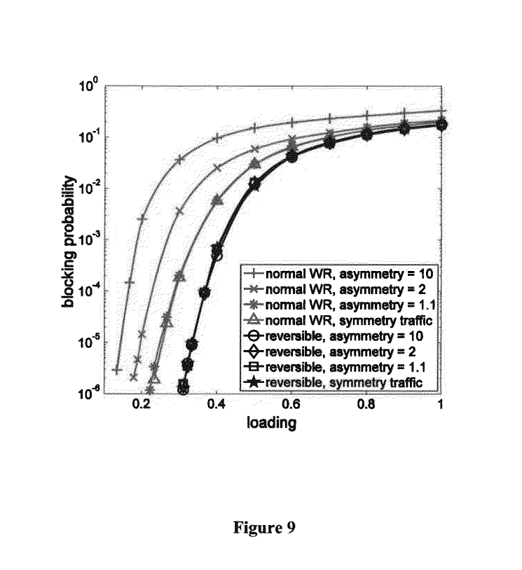

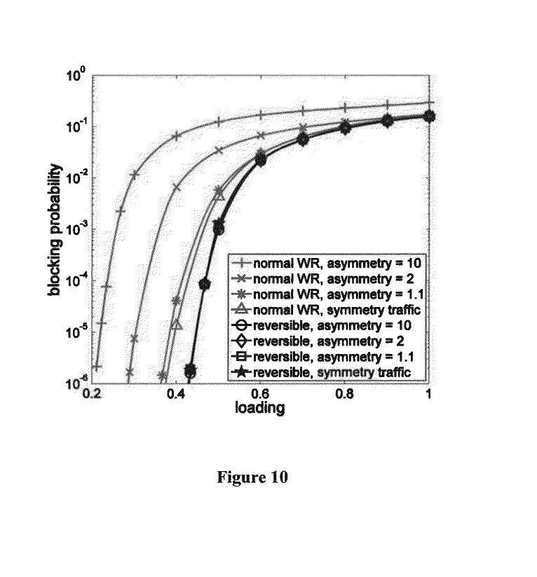

For the blocking performance of the proposed reversible wavelength channel approach in the cases of asymmetric traffic, we only show the results for the NSFNet topology network since other results are similar. FIGS. 9 and 10 show the simulation results for the cases of one and four fibers per link when the traffic between any pair of node is asymmetric. In the simulations, we flip a biased coin when two nodes are chosen for the source and destination. According to the outcome of the flip, we may swap the source and destination assignment such that the total traffic from one transmission direction over that from another direction will be on the average equal to an asymmetry factor. For convenience, asymmetry factor is equal to or large than one. Surely, a network with symmetric traffic will have an asymmetry factor of one. A network with larger asymmetry factor means that the traffic between each pair of nodes becomes more asymmetric. In FIGS. 9 and 10, the curves with triangles, asterisks, crosses, and pluses represent the results of normal WR networks with asymmetry factors of 1, 1.1, 2 and 10, respectively, while the curves with stars, squares, diamonds and circles are for those using reversible wavelength channels. From FIGS. 9 and 10, one can observe that normal WR networks will suffer greatly when the system traffic becomes asymmetric. On the other hand, it has surprisingly been found that reversible wavelength channel WR networks will have similar blocking performance even if the asymmetry factor increases from 1 to 10. As we discussed in previous paragraphs, reversible wavelength channel approach is conceptually equal to combine the capacities and traffic loadings of the two links originally having opposite transmission directions in normal WR networks. Modifying the ratio of loading traffic on the opposite direction links will not change the blocking probability if the total traffic loading remains unchanged. This demonstrates the effectiveness of the reversible wavelength channel approach in handling the frequent changes of network traffic patterns that we may not have foreseen. Though the reversible wavelength channel approach requires many WR network devices to be upgraded, the investment will provide significant advantages and flexibility.

### D. Discussion of Other Implementation Approaches

So far, we have assumed that all wavelength channels of all links in a WR network are reversible. From a practical point of view, this may be costly and not necessary in many occasions. For example, one may prefer to upgrade only some links of a network to have reversible wavelength channels. Clearly, it will be an interesting and complicated optimization problem to find out the proper locations and numbers of links to maximize the system performance with minimum hardware upgrade. Another implementation alternative is to use the reversible waveband approach. From FIG. 2, one may observe that the size of the optical switch in the bidirectional optical amplifier will grow with the number of wavelength channels. If the reversibility of transmission direction is waveband-based, waveband switches can be used to reduce the cost. Note that waveband reversibility is a compromise between performance and implementation cost. In some occasions, one may encounter a substantial reduction of reversibility gain.

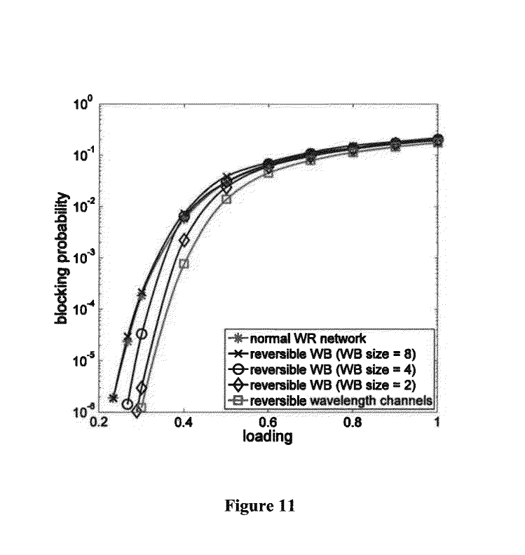

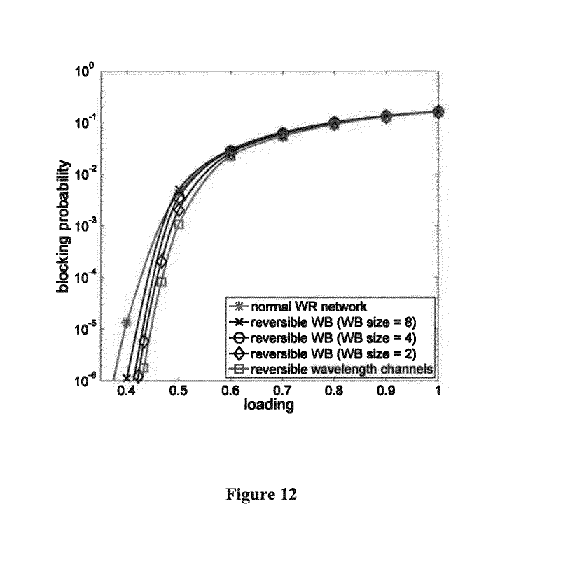

FIGS. 11 and 12 show the blocking performance of reversible waveband approach on the NSFNet topology network with one and four fibers per link using different waveband sizes. The 32 wavelength channels in a fiber are grouped into equal size wavebands. Hence, there will be 4, 8, and 16 wavebands in a fiber if the waveband sizes are 8, 4, and 2. The transmission direction of a waveband is freely configurable if all wavelength channels in the waveband are not occupied. Since waveband switches are used in bidirectional optical amplifiers, however, the transmission direction of the waveband will be fixed once any wavelength channel in the waveband has been used for transmission. Consequently, the set up of the lightpath will become more complicated because we have to consider the transmission direction of the waveband that an idle wavelength channel belongs. Also, we should prefer to use wavebands already having channels in transmission when setting up a lightpath. This is to maximize the number of free wavebands, and to have more flexibility in setting up additional lightpaths afterward.

In FIGS. 11 and 12, the curves with diamonds, circles, and crosses are blocking probabilities of the reversible waveband approach using waveband sizes of 2, 4, and 8, respectively. For reference, blocking probabilities of normal WR network and the reversible wavelength channel approach are plotted as the curves with asterisks and squares, respectively. From FIGS. 11 and 12, we observe that the reversible waveband approach with large waveband size will not always have better blocking performance than normal WR network. For example, the curve with crosses is above the curve with asterisks in FIG. 11. The reversible waveband approach will have blocking performance close to that of the reversible wavelength channel approach only if the waveband sizes are small enough, e.g., waveband sizes≦4. Hence, one has to balance the tradeoff between performance and implementation cost if the reversible waveband approach is used.

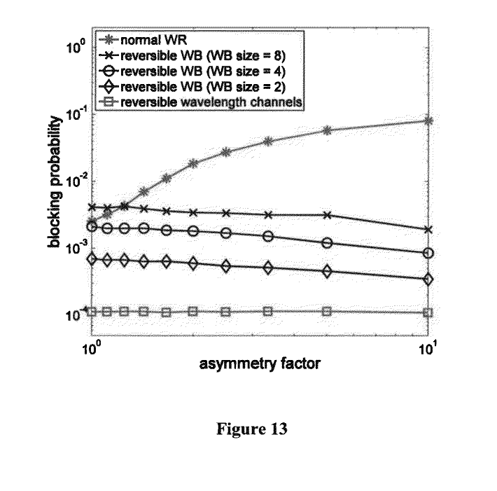

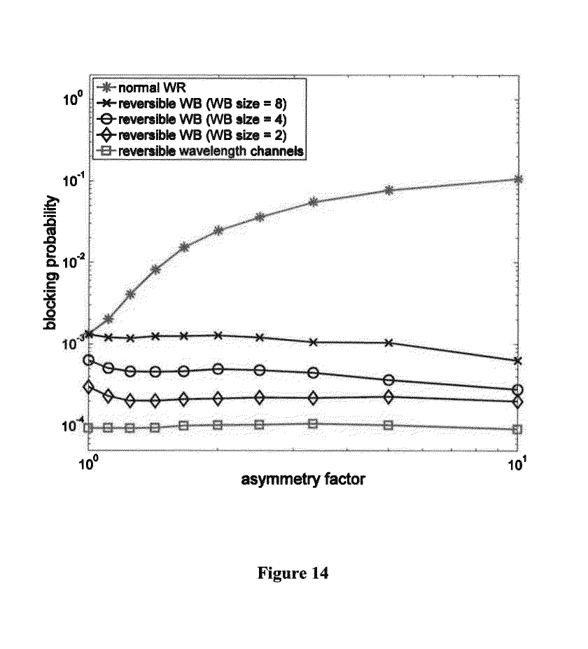

A nice feature of the reversible waveband approach is that its performance is also insensitive to asymmetric traffic. FIGS. 13 and 14 are the blocking performance of the reversible waveband approach in the NSFNet topology network with one and four fibers per link. The normalized loadings are set to 0.37 and 0.43 in the two networks such that the reversible wavelength channel approach will have blocking probability about 10⁻⁴. From the figures, we observe that the blocking performance of normal WR network degrades quickly with the increase of asymmetry factor while that of the reversible wavelength channel approach basically remains unchanged in the whole range of the asymmetry factor. On the other hand, the blocking probability of the reversible waveband approach decreases slightly when asymmetry factor increases from 1 to 10. This is because large asymmetry factor implies the traffic from any pair of nodes becomes more ‘unidirectional’. New lightpaths are easier to find channels available in wavebands with the required transmission direction. Hence, the bandwidth utilization of a waveband will be improved when the asymmetry factor is large.

Note that the blocking performance of the reversible waveband approach can be further improved with other methods such as non-uniform waveband size. For example, we find that the reversible waveband approach with non-uniform waveband size of {2, 2, 2, 2, 4, 4, 8, 8} will have better performance than that of uniform waveband size of 4. Nevertheless, it will become another interesting optimization problem when the number of wavelength channels is large.

We observe that in the real world traffic between users are often asymmetric and network traffic patterns change frequently. More flexible bandwidth utilization is desired. We therefore propose reversible wavelength channels to be used in wavelength-routed (WR) networks. Reversible lanes in highway systems have already been widely regarded as of one of the most cost-effective methods to provide additional capacity for periodic unbalanced directional traffic demand while minimizing the total number of lanes on a roadway. However, reversible wavelength channels so far have not been demonstrated in WR networks even though we observe that most of the required technologies are already available. In the present invention, we demonstrate that the reversible wavelength channel approach can provide significant performance improvement for WR networks when the traffic is asymmetric. Even if the traffic is symmetric, we also have nontrivial performance improvement with the reversible wavelength channel approach, i.e., the blocking performance of WR networks with reversible wavelength channels will be similar to that of normal WR networks with double the number of fibers per link. Different implementation approaches for reversible wavelength channels are demonstrated. Among them, the performance of the reversible waveband approach has been discussed in detail.

It should be understood that the above only illustrates and describes examples whereby the present invention may be carried out, and that modifications and/or alterations may be made thereto without departing from the spirit of the invention.

It should also be understood that certain features of the invention, which are, for clarity, described in the context of separate embodiments, may also be provided in combination in a single embodiment. Conversely, various features of the invention which are, for brevity, described in the context of a single embodiment, may also be provided or separately or in any suitable subcombination.

1. An optical transmission system comprising:
a first connection point;
a second connection point node; and
at least one optical medium connecting the first connection point to the second connection point and providing channels for transmitting channel signals between the first connection point and the second connection point, wherein each of the first and second connection points is reversibly configurable for transmission of channel signals in either a first direction from the first connection point to the second connection point or a second directions from the second connection point to the first connection point.

2. The optical transmission system according to claim 1, wherein each of the first connection point and the second connection point comprises bidirectional multiplexing means for multiplexing a plurality of input signals into at least one channel signal.

3. The optical transmission system according to claim 2, wherein each of the first connection point and the second connection point comprises bidirectional demultiplexing means for demultiplexing the at least one channel signal into a plurality of output signals.

4. The optical transmission system according to claim 1, further comprising bidirectional isolating means for limiting reflection of the channel signals.

5. The optical transmission system according to claim 1, further comprising bidirectional amplifying means for amplifying the channel signals.

6. The optical transmission system according to claim 1, wherein
the at least one optical medium comprises a first optical medium and a second optical medium, and
the optical transmission system further comprises a bidirectional optical switch for switching transmission of the at least one channel signal between the first optical medium and the second optical medium.

7. The optical transmission system according to claim 2, further comprising a bidirectional signal converter for converting the channel signals so that at least one of the channel signals is converted for transmission by the at least one optical medium.

8. The optical transmission system according to claim 1, wherein the at least one optical medium comprises at least one optical fiber.

9. The optical transmission system according to claim 1, wherein the channel signals comprise at least one wavelength channel.

10. The optical transmission system according to claim 1, wherein at least one of the first connection point and the second connection point comprises an electronic device.

11. The optical transmission system according to claim 3, wherein
the at least one optical medium comprises a first optical medium and a second optical medium, and
the optical transmission system further comprises
bidirectional isolating means for limiting reflection of the at least one channel signal,
bidirectional amplifying means for amplifying the at least one channel signal,
a bidirectional optical switch for switching transmission of the at least one channel signal between the first optical medium and the second optical medium, and
a bidirectional signal converter for converting the at least one channel signal so that the at least one channel signal is converted for transmission by the at least one optical medium, wherein
the at least one optical medium comprises at least one optical fiber, and
the at least one channel signal comprises at least one wavelength channel.

12. A method of transmitting at least one channel signal between a first connection point and a second connection point via at least one optical medium in an optical transmission system, the method comprising:
multiplexing a plurality of input signals into at least one channel signal;
transmitting the at least one channel signal via the at least one optical medium; and
demultiplexing the at least one channel signal into a plurality of output signals, wherein each of the at least one channel signals is reversibly configurable for transmission in either a first direction or a second direction between the first connection point and the second connection point.

13. The method of transmitting at least one channel signal via an optical medium in an optical transmission system according to claim 12, further comprising limiting reflection of the at least one channel signal after the multiplexing.

14. The method of transmitting at least one channel signal via an optical medium in an optical transmission system according to claim 12, further comprising amplifying the at least one channel signal after the multiplexing.

15. The method of transmitting at least one channel signal via an optical medium in an optical transmission system according to claim 12, wherein
the at least one optical medium comprises a first optical medium and a second optical medium, and
the method further comprises switching the at least one channel signal between the first optical medium and the second optical medium.

16. The method of transmitting at least one channel signal via an optical medium in an optical transmission system according to claim 12, further comprising converting the at least one channel signal for transmission by the at least one optical medium.

17. The method of transmitting at least one channel signal via an optical medium in an optical transmission system according to claim 12, wherein
the at least one optical medium comprises a first optical media and a second optical medium, and
the method further comprising
limiting reflection of the at least one channel signal after the multiplexing,
amplifying the at least one channel signal after the multiplexing,
switching the at least one channel signal between the first optical medium and the second optical medium, and
converting the at least one channel signal for transmission by the at least one optical medium.

18. A method of transmitting channel signals between a first connection node and a second connection node via first and second optical media in an optical transmission system, the method comprising:
multiplexing a plurality of input signals of the first connection node into a first channel signal;
transmitting the first channel signal via the first optical medium from the first connection node to the second connection node;
demultiplexing the first channel signal into a plurality of output signals at the second connection node;
reversing configuration of the first connection node and the second connection node;
multiplexing a plurality of input signals of the second connection node into a second channel signal;
transmitting the second channel signal via the first optical medium from the second connection node to the first connection node; and
demultiplexing the second channel signal into a plurality of output signals at the first connection node.

19. The method of transmitting channel signals according to claim 18, further comprising amplifying the first channel signal before transmitting the first channel signal.
